(19) United States
(12) Patent Application Publication
(10) Pub. No.: US 2015/0316743 A1
(43) Pub. Date: Nov. 5, 2015

(54) Devices and Methods for Providing Optical Element Focus Functionality with Position Retention

(71) Applicant: Google Inc., (US)

(72) Inventor: Roman Lewkow, Mountain View, CA (US)

(73) Assignee: Google Inc., Mountain View, CA (US)

(21) Appl. No.: 13/845,242

(22) Filed: Mar. 18, 2013

(51) Int. Cl. G02B 7/04

(52) U.S. Cl. CPC G02B 7/04

(57) ABSTRACT

Devices and methods for providing low power lens focus functionality with position retention are provided. In one example, a device is provided that comprises an optical element assembly configured to provide a plurality of focus settings based on a change in a position of the optical element assembly. The device also includes a first actuator configured to cause the change in the position. The device also includes a second actuator configured to retain the optical element assembly in the position. The change in the position causes the optical element assembly to be configured in a given focus setting of the plurality of focus settings.

### BACKGROUND

Unless otherwise indicated herein, the materials described in this section are not prior art to the claims in this application and are not admitted to be prior art by inclusion in this section.

A camera lens is an optical lens or an assembly of lenses used with a camera body to project images of objects onto a focal plane of a recording element. The images may be recorded on photographic film or on other media capable of storing the image chemically or electronically. Example cameras may include still cameras, video cameras, telescopes, microscopes or other apparatus.

In some examples, example camera lens may include a lens assembly that is coupled to an actuator to change a focus setting of the lens assembly. The actuator coupled to the lens assembly may consume power to accomplish the change in focus. The actuator may consume additional power to retain the lens assembly in the focus setting.

### SUMMARY

In one example, a device is provided that comprises an optical element assembly configured to focus light and provide a plurality of focus settings based on a change in a position of the optical element assembly. The device also comprises a first actuator coupled to the optical element assembly that is configured to cause the change in the position of the optical element assembly. The device also comprises a second actuator coupled to the optical element assembly that is configured to retain the optical element assembly in the position.

In another example, a device is provided that comprises an optical element assembly configured to focus light and provide a plurality of focus settings based on a change in a position of the optical element assembly. The optical element assembly comprises a plurality of mechanical dents arranged along a plurality of positions. The device also comprises an actuator coupled to the optical element assembly that is configured to cause the change in the position of the optical element assembly. The device also comprises at least one structure coupled to the optical element assembly configured to retain the optical element assembly in one of the plurality of positions by coupling to at least one of the plurality of mechanical dents. The plurality of positions corresponds to the plurality of focus settings.

In still another example, a method performed by a device including an optical element assembly configured to focus light is provided. The method comprises providing a plurality of focus settings based on a change in a position of the optical element assembly. The method further comprises providing a first actuator coupled to the optical element assembly that is configured to cause the change in the position of the optical element assembly. The method further comprises providing a second actuator coupled to the optical element assembly that is configured to retain the optical element assembly in the position. The method further comprises reducing power to the first actuator based on the second actuator retaining the optical element assembly in the position.

In still another example, a device is provided comprising a means for providing a plurality of focus settings based on a change in a position of an optical element assembly configured to focus light. The device also comprises a means for providing a first actuator coupled to the optical element assembly that is configured to cause the change in the position of the optical element assembly. The device also comprises a means for providing a second actuator coupled to the optical element assembly that is configured to retain the optical element assembly in the position. The device also comprises a means for reducing power to the first actuator based on the second actuator retaining the optical element assembly in the position.

These as well as other aspects, advantages, and alternatives, will become apparent to those of ordinary skill in the art by reading the following detailed description, with reference where appropriate to the accompanying figures.

### BRIEF DESCRIPTION OF THE FIGURES

FIG. 1A illustrates a block diagram of an example device.

FIG. 1B illustrates another embodiment of an example device.

FIG. 2 illustrates another example device.

FIG. 3 illustrates a side view cross-section of an example device that may be configured as a lens module.

FIG. 4 illustrates a side view cross-section of another example device that may be configured as a lens module.

FIG. 5 is a block diagram of an example method for providing focus settings of a device that includes an optical element assembly, in accordance with at least some embodiments described herein.

### DETAILED DESCRIPTION

The following detailed description describes various features and functions of the disclosed systems and methods with reference to the accompanying figures. In the figures, similar symbols identify similar components, unless context dictates otherwise, and components within the figures may not be drawn to scale for illustration purposes. The illustrative system and method embodiments described herein are not meant to be limiting. It may be readily understood that certain aspects of the disclosed systems and methods can be arranged and combined in a wide variety of different configurations, all of which are contemplated herein.

Within camera lens modules, it may be desirable to change a position of a lens assembly included in the camera lens module to achieve a given focus setting. The camera lens module may utilize an actuator to accomplish the change in the position. The actuator may consume power to accomplish the change in the position. In addition, the actuator may consume power to retain the lens assembly in the position.

Within examples described herein, a device configured as a camera lens module includes an actuator coupled to a lens assembly in the camera lens module that may cause a change in a position of the lens assembly to achieve a given focus setting from a plurality of focus settings. In addition, the device may be configured to retain the lens assembly in the position by way of a retention structure independent from use of the actuator. Thus, the focus setting that is selected may be one of a plurality of predefined focus settings due to predefined positions of the lens assembly. In other examples, the focus settings may be one of any setting along a continuous range of settings due to a continuous range of possible positions of the lens assembly.

Within a specific example, a device is provided that includes an optical element assembly coupled to a first actuator that is configured to cause a change in a position of the optical element assembly. The change in the position of the optical element assembly corresponds to one of a plurality of focus settings of the device. A second actuator included in the device may be configured to retain the optical element assembly in the position.

In addition, the device may further comprise a driver coupled to the first actuator and configured to reduce power to the first actuator based on the optical element assembly being in the position. In some examples, the driver may be coupled also to the second actuator and configured to control power to the second actuator. In other examples, a second driver may be included in the device that is configured to control power to the second actuator.

In some examples, the second actuator may be configured to retain the optical element assembly by applying at least one force that is substantially perpendicular to an axis of motion of the optical element assembly. In other examples, the at least one force may be configured to be substantially parallel to the axis of motion of the optical element assembly.

In some examples, the second actuator may comprise one or more electromechanical brakes coupled to the optical element assembly and configured to apply mechanical resistance to a motion of the optical element assembly based on the optical element assembly being in the position. For instance, the one or more electromechanical brakes may include a spring that is configured to retain the optical element assembly in the position. In some example configurations, the electromechanical brakes are energized and the spring is compressed to allow the first actuator to change the position of the optical element assembly. In other example configurations, the one or more electromechanical brakes may be energized to retain the optical element assembly in the position and de-energized to allow the first actuator to change the position of the optical element assembly.

In further examples, at least one spring may be included in the device and configured to also cause the change in the position of the optical element assembly. The at least one spring may be configured to cause the change in the position along the axis of motion of the optical element assembly caused by the first actuator. In other examples, the at least one spring may be configured to also retain the optical element assembly in the position.

Within another specific example, a device is provided that includes an optical element assembly configured to focus light. The optical element assembly may be configured to include a plurality of mechanical dents arranged along a plurality of positions corresponding to a plurality of focus settings the device is configured to provide. The device may also include an actuator coupled to the optical element assembly and configured to cause a change in a position of the optical assembly corresponding to a given position of the plurality of positions. The device may also include at least one structure configured to retain the optical element assembly in one of the plurality of positions by coupling to one of the plurality of mechanical dents.

In some examples, the device may further include a retention structure coupled to the optical element assembly and configured to apply substantially continuous friction along an axis of motion of the optical element assembly to retain the optical element assembly in the position.

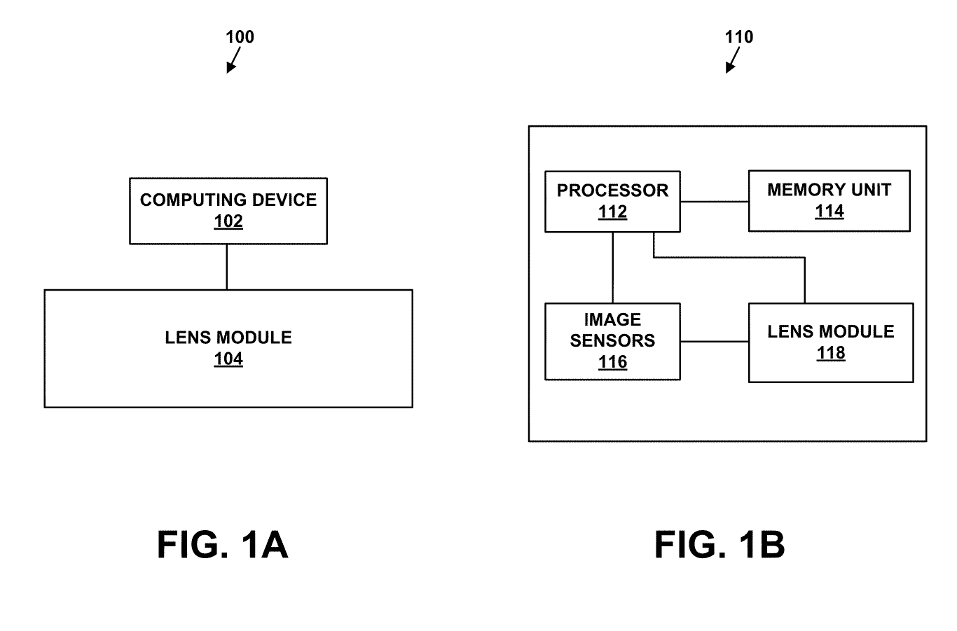

FIG. 1A illustrates a block diagram of an example device 100. The device 100 may include a computing device 102 that is coupled to a lens module 104. The computing device 102 may be coupled to the lens module 104, for example, mechanically, opto-electrically through electrical circuitry, or by using electrical cables.

The computing device 102, for example, may be or may include a camera, a handheld device, a computer, a head-mounted device, or other wearable computing device. In some examples, the computing device 102 may include a battery to provide power to the computing device 102 and the lens module 104. In other examples, the computing device 102 may receive power from a power unit and provide power to the lens module 104.

The lens module 104 may include image sensors that receive light focused by a plurality of optical element assemblies included in the lens module 104. In other examples, the image sensors may be included in the computing device 102. In one example, the lens module 104 may also include a first actuator configured to change the position of the lens module 104 to a position corresponding to one of a plurality of focus settings. In another example, the lens module 104 may be moved to a position along a continuous range of positions, each of which corresponds to a given focus setting (and thus, any of a continuous range of focus settings may be selected). The lens assembly 104 may also include a second actuator configured to retain the lens assembly 104 in the position.

The device 100 may be configured to receive light focused by the lens module 104 and provide data indicative of an image represented by the light focused. In some examples, the device 100 may store the data as well or provide the data to a display that may be included in the device 100.

FIG. 1B illustrates another embodiment of an example device 110. The device 110 may include a processor 112, a memory unit 114 and image sensors 116 to facilitate processing and storage of data from image sensors 116. Image sensors 116, for example, are coupled to a lens module 118 that is shown included in the device 110, which may be configured to receive light focused by the lens module 118.

The device 110, for example, may be or include a camera, a handheld device, a computer or a head-mounted device, or other wearable computing device. In some examples, the device 110 may include a battery to provide power to the device 110 and components included in the device 110. In other examples, the device 110 may receive power from a power unit and provide power to the components included in the device 110. For example, the device 110 may include the processor 112, the memory unit 114, image sensors 116, and the lens module 118. The device 110, for example, may also include other circuitry (not shown) including at least one driver for the lens module 118.

The processor 112, for example, may be configured to receive data from the image sensors 116 indicative of an image focused by the image sensors 116. The processor 112 may further process the data and provide the data for storage in memory unit 114. The processor 112 may also process the data and provide the processed data to a display (not shown). The processor 112 may also be configured to provide instructions for other components in the device 110 to facilitate capturing the image at a correct focus. The instructions may include instructions to drive the lens module 118 to provide a given focus setting from a plurality of focus settings or a continuous range of focus settings that corresponds to a desired image focus.

The memory unit 114 included in FIG. 1B may include, for example, static memory or a media storage device. For example, the memory unit 114 may comprise an SD card or a USB memory device. The memory unit 114 may also be configured, for example, to store image data provided by the processor 112 and to provide image data stored on the memory unit 114 to the processor 112. The memory unit 114 may also comprise chemical storage. For example, a photography film may be utilized to chemically store the image data.

The image sensors 116 included in FIG. 1B may include, for example, an array of semiconductor pixel sensors (e.g., a CMOS image sensor or similar device) configured to receive light focused by the lens module 118 and provide data indicative of the image focused by lens module 118. In other examples, the image sensors 116 may be a charge-coupled device (CCD). The image sensors may be coupled to a printed circuit board and aligned with optical axes of optical element assemblies included in the lens module 118.

The lens module 118 may include one or more optical element assemblies. The one or more optical element assemblies focus light entering the lens module 118 onto the image sensors 116. The lens module 118 may be configured to change a focus setting of the one or more optical element assemblies due to instructions received from processor 112. The lens module 118 may also include a first actuator configured to change the position of the lens module 118 to a position corresponding to one of a plurality of focus settings. The lens assembly 18 may also include a second actuator configured to retain the lens assembly 118 in the position.

The device 110 may be configured to receive light focused by the lens module 118 onto image sensors 116 and provide data indicative of an image represented by the light focused to the processor 112. For example, the device 110 may utilize the processor 112 to configure the lens module 118 to a given focus setting. The processor 112 may then utilize the image sensors 116 to capture an image generated by lens module 118 and store the image in the memory unit 114. In other examples, the device 110 may utilize processor 112 to process data representing the captured image or retrieve data from memory unit 114, process the data, and provide data for display.

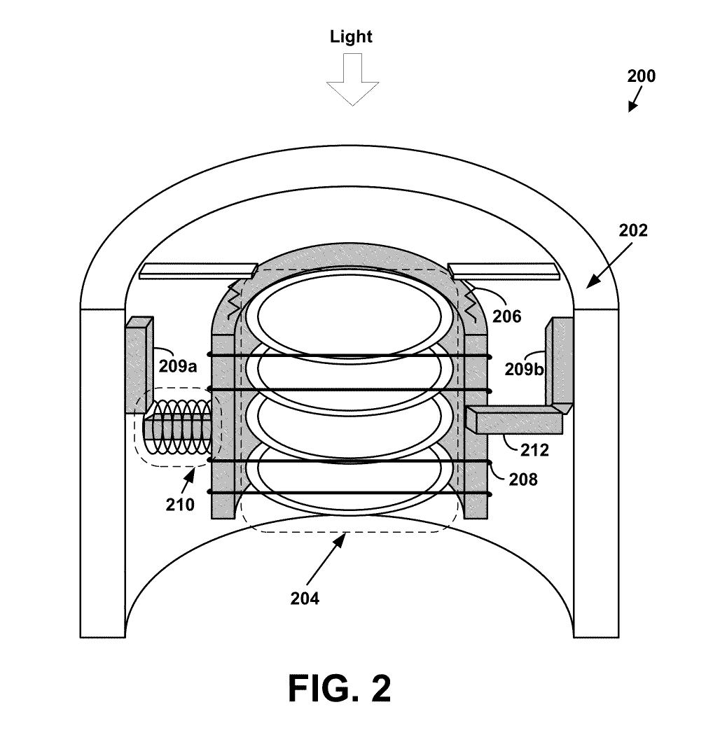

FIG. 2 illustrates another example device 200. The device 200 may be configured as a lens module. The device 200 may include an enclosure structure 202 that houses the various components of the device 200. The device 200 includes an optical element assembly 204 coupled to the enclosure structure 202 by at least one spring 206. The device 200 may also include a first actuator 208 configured to cause a change in a position of the optical element assembly 204 by interaction with magnets 209a-b. The device 200 may also include a second actuator 210 coupled to the optical element assembly 204 and configured to retain the optical element assembly 204 in the position. The device 200 may also include a support structure 212 that may be utilized with the second actuator 210 to retain the optical element assembly 204 in the position.

Enclosure structure 202 included in the device 200 may comprise a plastic, a metal or a composite structure that is coupled to the optical element assembly 204 by the at least one spring 206. The enclosure structure 202 may be included in a computing device (not shown) coupled to the device 200 or may be independent of the computing device. In some examples, the enclosure structure 202 may have the shape of a cube, a cylinder, or another shape.

The optical element assembly 204 may comprise one or more optical elements. The optical elements may comprise lens, mirrors, prisms, filters or any other component that is configured to process light passing through the one or more optical elements. Light may be focused, for example, due to a diffraction property or a reflective property of the one or more optical elements. The optical element assembly 204 may also include an optical element barrel configured to hold the one or more optical elements in a fixed spatial arrangement.

The at least one spring 206 may be a compression spring, german hook, english hook or any other spring that is coupled to the optical element assembly 204 and the enclosure structure 202 to cause the optical element assembly 204 to move along an axis of motion.

The first actuator 208 is coupled to the optical element assembly 204 and may be configured to cause the change in the position of the optical element assembly 204 along the axis of motion. The first actuator 208 may comprise a voice coil motor, a piezoelectric actuator, MEMS or a shape memory alloy. In some examples, the first actuator 208 may comprise an electromagnetic coil coupled with at least one magnet. A first magnetic field of the electromagnetic coil may interact with a second magnetic field of the at least one magnet to cause the change in the position of the optical element assembly 204.

The second actuator 210 is coupled to the optical element assembly 204 and may be configured to retain the optical element assembly 204 in the position. The second actuator may comprise an electromechanical brake, a spring-loaded electromechanical brake, a voice coil motor, a piezoelectric motor, MEMS or a shape memory alloy.

The support structure 212 may comprise, for example, a plastic, a metal or a composite structure configured to support the second actuator 212 in retaining the optical element assembly 204 in the position.

Light entering the device 200 may be focused through the optical element assembly 204 in one of a plurality of focus settings along a continuous range of possible settings. The first actuator 208 may be configured to cause a change in a position of the optical element assembly 204 corresponding to another focus setting of the plurality of focus settings. The device 200 may be configured to reduce power to the first actuator 208 based on the optical element assembly 204 being in the position. The device 200 may also be configured to utilize the second actuator 210 and the support structure 212 to retain the optical element assembly 204 in the position. For example, the second actuator 210 may be configured to apply a force perpendicular to the axis of motion of the optical element assembly 204 against the support structure 212 such that the optical element assembly 204 may be retained in the position. In other examples, the second actuator 210 may be configured to apply mechanical resistance against a motion of the optical element assembly 204.

Although illustrated in FIG. 2 that device 200 includes one second actuator 210 and one support structure 212, the device 200 may be configured to include additional actuators and support structures to replace or complement the second actuator 210 and the support structure 212. This may be performed, for example, to make perpendicular retaining forces more symmetric (balanced) and to reduce de-centering of the optical assembly 204.

In other examples not illustrated in FIG. 2, the second actuator 210 may be arranged to apply a force parallel to the axis of motion of the optical element assembly 204. For instance, the second actuator 210 may be placed above or below the optical element assembly 204 and configured to apply the force along the axis of motion of the optical element assembly 204.

Although illustrated that the device 200 includes one optical element assembly 204, the device 200 may include more optical element assemblies than illustrated in FIG. 2. For example, the device 200 may include two or more optical element assemblies. Such optical element assemblies may share common actuators or may each be actuated and retained individually.

In the device 200, the position of the optical element assembly 204 corresponds to one of the plurality of focus settings of the device 200. For example, the change in the position of the optical element assembly 204 to a different position corresponds to a given focus setting of the plurality of focus settings.

In the device 200, the at least one spring 206 is coupled to the optical element assembly 204 and the enclosure structure 202. The at least one spring 206 may include more than one spring and may be configured, for example, to suspend the optical element assembly 204 inside the enclosure structure 202.

In some example configurations of the device 200, the at least one spring 206 may be configured to also cause the change in the position of the optical element assembly 204. For example, the first actuator 208 may be configured to cause the change in the position of the optical element assembly 204 along one direction of the axis of motion and the at least one spring 206 may be configured to cause the change in the position of the optical element assembly 204 along another direction of the axis of motion. As shown in FIG. 2, for example, the optical element assembly 204 may be moved up or down (referring to an orientation of the device 200 in FIG. 2) along an axis in which light is received. The optical element assembly 204 may also be configured to move side-to-side, or possibly in a diagonal direction with respect to the axis along which light is received, for example.

In other example configurations of the device 200, the at least one spring 206 may be configured to retain the optical element assembly 204 in the position. For instance, the first actuator 208 may be configured to cause the change in the position of the optical element assembly 204 along one direction of the axis of motion and the at least one spring 206 may be configured to prevent the optical element assembly 204 from further moving along the one direction.

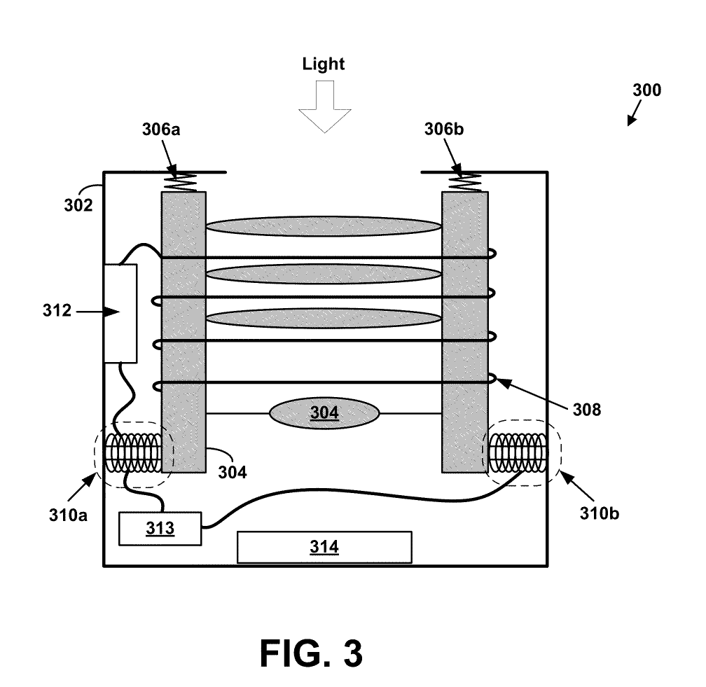

FIG. 3 illustrates a side view cross-section of an example device 300 that may be configured as a lens module. The device 300 may be similar to or the same as the device 200 shown in FIG. 2 and may include an enclosure structure 302 that houses the various components of the device 300. The device 300 includes an optical element assembly 304 coupled to the enclosure structure 302 by at least one spring 306a-b. The device 300 may also include a position actuator 308 configured to cause a change in a position of the optical element assembly 304. The device 300 may also include retention actuators 310a-b coupled to the optical element assembly 304 and configured to retain the optical element assembly 304 in the position. The device 300 may also comprise a driver 312 configured to control power to the position actuator 308 and the retention actuators 310a-b. The device 300 may also include an image sensor 314 configured to receive light focused by the optical element assembly 304.

Components in the device 300 may be similar to components of the device 200 in FIG. 2, such as the enclosure structure 302, the optical element assembly 304, the springs 306a-b, the position actuator 308 and the retention actuators 310a-b.

The driver 312 included in the device 300 may comprise, for example, an electronic component or a printed circuit board coupled to the position actuator 308 and the retention actuators 310a-b by, for example, electrical wires or an electrical cable. The driver 312 may be configured to control power to the position actuator 308 and the retention actuators 310a-b. In some examples, the driver 312 may be coupled to a computing device (not shown) and configured to receive instructions indicative of applying power to the position actuator 308 or the retention actuators 310a-b. In other examples, the driver 312 may be included in the computing device.

The image sensor 314 may be configured to receive light focused by the optical element assembly 304 and provide data indicative of an image focused by the optical element assembly 304 to the computing device (not shown). The image sensor 314 may comprise, for example an array of semiconductor pixel sensors (e.g., a CMOS image sensor or a similar device). In other examples, the image sensor 314 may comprise a charge-coupled device (CCD). The image sensor 314, for example, may be coupled to a printed circuit board and aligned with an optical axis of the optical element assembly 304.

Light entering the device 300 may be focused through the optical element assembly 304 in one of a plurality of focus settings. The position actuator 308 may be configured to cause a change in a position of the optical element assembly 304 corresponding to another focus setting of the plurality of focus settings or of a continuous range of settings. The device 300 may also be configured to utilize the retention actuators 310a-b to retain the optical element assembly 304 in the position.

Although illustrated in FIG. 3 that the driver 312 is coupled to both the position actuator 308 and the retention actuators 310a-b, the device 300 may be configured to include a second driver 313 coupled to the retention actuators 310a-b such that the driver 312 is not coupled to the retention actuators 310a-b, or both the driver 312 and the second driver 313 couple to the retention structures 310a-b. The second driver 313 may be configured to control power to the retention actuators 310a-b.

In some examples, the driver 312 or the second driver 313 may be configured to reduce power to the position actuator 308 based on the optical assembly 304 being in the position corresponding to one of the plurality of focus settings. For example, the driver 312 may apply power to the position actuator 308 to cause the change in the position of the optical element assembly 304. The driver 312 may also be configured to cause the retention actuators 310a-b to retain the optical assembly 304 in the position. The driver may also be configured to reduce power to the position actuator 308 based on the retention actuators 310a-b retaining the optical element assembly 304 in the position.

In some example configurations of the retention actuators 310a-b, the retention actuators 310a-b may be configured to retain the optical element assembly 304 based on the driver 312 reducing power to the retention actuators 310a-b. For example, the retention actuators 310a-b may comprise an electromechanical brake coupled to a spring (spring-loaded electromechanical brake). The spring may be configured to be extended based on the driver 312 reducing power to the electromechanical brake to retain the optical element assembly 304 in the position. The spring may also be configured to be compressed based on the driver 312 increasing power to the electromechanical brake to allow the position actuator 308 to cause the change in the position of the optical element assembly 304.

In other example configurations, the retention actuators 310a-b may be configured to retain the optical element assembly 304 based on the driver 312 increasing power to the retention actuators 310a-b. For example, the retention actuators 310a-b may comprise a Voice Coil Motor (VCM) configured to apply a force on the optical element assembly 304 corresponding to the driver 312 increasing power to the VCM. The force applied by the VCM may be configured to retain the optical element assembly 304 in the position.

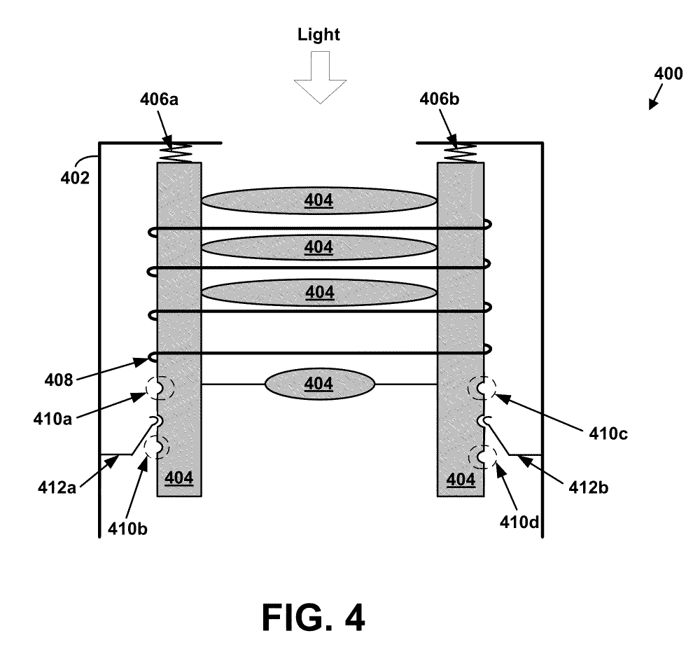

FIG. 4 illustrates a side view cross-section of an example device 400 that may be configured as a lens module. The device 400 may be similar to or the same as the device 200 shown in FIG. 2 and may include an enclosure structure 402 that houses the various components of the device 400. The device 400 may include an optical element assembly 404 coupled to the enclosure structure 402 by springs 406a-b. The device 400 may also include an actuator 408 configured to cause a change in a position of the optical element assembly 404. The device 400 may also comprise a plurality of mechanical dents 410a-d included in the optical element assembly 404 and configured in a plurality of positions corresponding to a plurality of focus settings of the device 400. The device 400 may also include structures 412a-b configured to retain the optical element assembly 404 in a given position of the plurality of positions by coupling to at least one of the plurality of mechanical dents 410a-d.

Components in the device 400 may be similar to components of the device 200 in FIG. 2, such as the enclosure structure 402, the optical element assembly 404, the springs 406a-b and the actuator 408.

The plurality of mechanical dents 410a-d may be included in the optical element assembly 404. For example, an optical element barrel that may be included in the optical element assembly 404 may comprise the plurality of mechanical dents 410a-d. The plurality of mechanical dents 410a-d may be configured in the plurality of positions corresponding to the plurality of focus settings of the device 400.

The structures 412a-b included in device 400 may comprise a spring, a hook or an elastic material configured to couple with at least one of the plurality of mechanical dents 410a-d.

Light entering the device 400 may be focused through the optical element assembly 404 in one of the plurality of focus settings. The actuator 408 may be configured to cause a change in a position of the optical element assembly 404 corresponding to another focus setting of the plurality of focus settings. The plurality of mechanical dents 410a-d may be configured in the plurality of positions corresponding to the plurality of focus settings. The structures 412a-b may be configured to couple with at least one of the plurality of mechanical dents 410a-d to retain the optical element assembly 404 in one of the plurality of positions corresponding to a given focus setting of the plurality of focus settings.

In one example, the optical element assembly 404 may be moved by actuation of the actuator 408 along an axis parallel to the axis of which light is received. The structures 412a-b may engage and disengage with the mechanical dents 410a-d as the optical element assembly moves. The actuator 408 may be configured to apply a force to the optical element assembly 404 great enough to snap or slide the structures 412a-b out of the mechanical dents 410a-d to move the optical element assembly 404 to a desired focus setting, for example. At the desired focus setting, the structures 412a-b will fit into corresponding mechanical dents 410a-d to lock or retain the optical element assembly 404 in place, and power to the actuator 408 can be reduced or paused since a force by the actuator 408 may no longer be needed to hold the optical element assembly 404 in place.

In some examples, the device 400 may be configured to reduce power to the actuator 408 based on the optical element assembly 404 being in the position corresponding to one of the plurality of focus settings.

In some examples, the springs 406a-b may be configured to also retain the optical element assembly in the position corresponding to one of the plurality of focus settings. For example, the actuator 408 may cause the change in the position of the optical element assembly 404 along one direction. The at least one structure 412a-b may be configured to prevent the optical element assembly 404 from moving further along the one direction and the springs 406a-b may be configured to prevent the optical element assembly 404 from moving back along another direction.

Although not illustrated in FIG. 4, the device 400 may further comprise a retention structure configured to provide substantially continuous friction along an axis of motion of the optical element assembly 404. The substantially continuous friction may be configured to also retain the optical element assembly 404 in the position. For example, the retention structure may comprise one more springs coupled to the optical element assembly 404. The one or more springs may be configured to apply the substantially continuous friction to the optical element assembly 404.

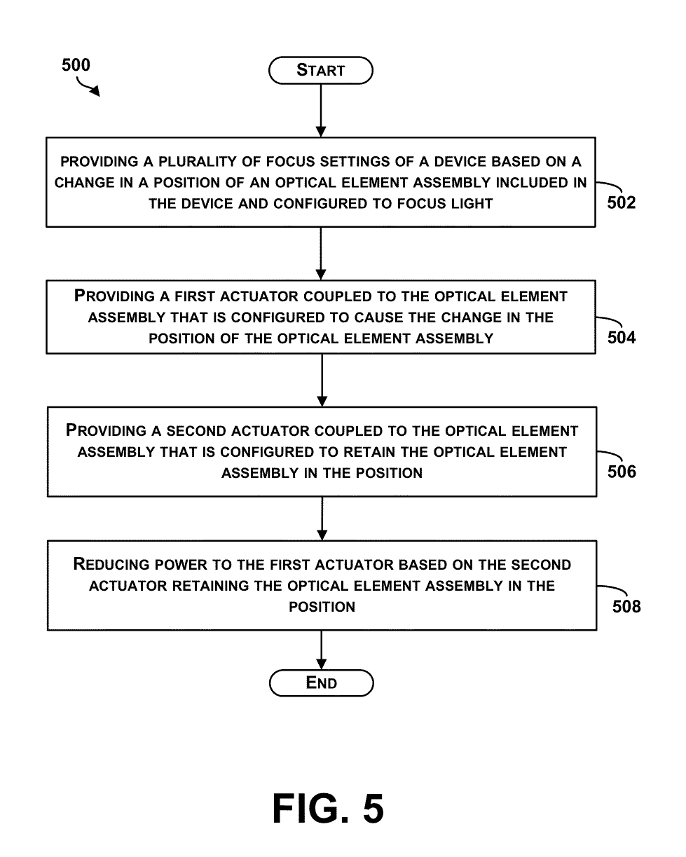

FIG. 5 is a block diagram of an example method for providing focus settings of a device that includes an optical element assembly, in accordance with at least some embodiments described herein. Method 500 shown in FIG. 5 presents an embodiment of a method that could be used with the devices 100, 200, 300, and 400, for example. Method 500 may include one or more operations, functions, or actions as illustrated by one or more of blocks 502-508. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for the method 500 and other processes and methods disclosed herein, the flowchart shows functionality and operation of one possible implementation of present embodiments. In this regard, each block may represent a module, a segment, or a portion of a manufacturing or operation process.

At block 502, the method 500 includes providing a plurality of focus settings (or a continuous range) of a device based on a change in a position of an optical element assembly included in the device and configured to focus light.

At block 504, the method 500 includes providing a first actuator coupled to the optical element assembly and configured to cause the change in the position of the optical element assembly. The plurality of focus settings correspond to a position of the optical element assembly. For example, one of the plurality of focus settings may correspond to the optical element assembly being in the position to bring far objects into sharp focus. Another of the plurality of focus settings may correspond to the optical element assembly being in the position to bring near objects into sharp focus. In further examples, the optical element assembly may be configured in a continuous range of settings (not only in predefined settings).

At block 506, the method 500 includes providing a second actuator coupled to the optical element assembly and configured to retain the optical element assembly in the position.

At block 508, the method 500 reduces power to the first actuator based on the second actuator retaining the optical element assembly in the position. In some examples, the second actuator may be powered only for a duration of assembly motion, and may be configured to passively hold the assembly in position.

Although not illustrated in FIG. 5, the second actuator may be configured to retain the optical element assembly in the position based on reducing power to the second actuator. For example, the second actuator may comprise a spring that extends based on reducing power to the second actuator to retain the optical element assembly. The method 500 may further include reducing power to the second actuator based on the optical element assembly being in the position.

In other examples, the second actuator may be configured to retain the optical element assembly in the position based on increasing power to the second actuator. For example, the second actuator may comprise a Voice Coil Motor (VCM) configured to apply a force on the optical element assembly based on increasing power to the VCM. The force may be configured to retain the optical element assembly in the position. The method 500 may further include increasing power to the second actuator based on the optical element assembly being in the position.

Operation of the device may be controlled, for example, by power input to the device, or by other components, circuitry, or processors coupled to the device. Example devices may include, for example, imaging devices such as document and image scanners, barcode readers, copiers, cameras, video cameras, microscopes, hand-held devices, head-mounted devices, wearable devices or telescopes.

Within examples, focusing techniques that are described for the device can be applied to other electronic devices that focus light. For example, projection devices such as displays and industrial laser etching systems may focus light using the methods described herein. Thus, example methods herein provide light focusing techniques that involve one or more optical element assemblies, an actuator configured to cause a change in a position of the one or more optical element assemblies corresponding to a plurality of focus settings, and retaining the one or more optical element assemblies in the position independently from the actuator.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

1. A device comprising:
an optical element assembly configured to focus light and provide a plurality of focus settings based on a change in a position of the optical element assembly, wherein the optical element assembly is configured to receive light along an axis of motion at a first end of the optical element assembly;
a first actuator coupled to the optical element assembly that is configured to cause the change in the position of the optical element assembly;
a second actuator directly connected to a surface of a second end of the optical element assembly that is configured to retain the optical element assembly in a resulting position after the change in the position, wherein the second actuator is configured to retain the optical element assembly by applying at least one force to the second end of the optical element assembly that is parallel to the axis of motion of the optical element assembly, wherein the second end of the optical element assembly is opposite the first end; and
a driver coupled to the first actuator that is configured to reduce power to the first actuator based on the optical element assembly being in the resulting position, and the driver is also coupled to the second actuator and is configured to control power to the second actuator, wherein increasing power to the second actuator causes the second actuator to retain the optical element assembly in the resulting position due to a configuration of the second actuator, and wherein the driver is configured to increase power to the second actuator based on the optical element assembly being in the resulting position.

2.-5. (canceled)

6. The device of claim 1, further comprising:
a second driver coupled to the second actuator that is configured to control power to the second actuator.

7.-8. (canceled)

9. The device of claim 1, wherein the second actuator comprises one or more electromechanical brakes coupled to the optical element assembly and configured to apply mechanical resistance against a motion of the optical element assembly based on the optical element assembly being in the resulting position.

10. The device of claim 9, wherein the second actuator further comprises at least one spring coupled to the one or more electromechanical brakes and configured to apply the mechanical resistance against the motion of the optical element assembly.

11. The device of claim 1, further comprising:
at least one spring configured to also cause the change in the position of the optical element assembly along an axis of motion of the optical element assembly.

12. The device of claim 11, wherein the first actuator is configured to cause the change in the position of the optical element assembly also along the axis of motion of the optical element assembly.

13. The device of claim 1, further comprising:
at least one spring configured to also retain the optical element assembly in the resulting position.

14. The device of claim 1, wherein the second actuator comprises one or more of an electromechanical brake, a spring-loaded electromechanical brake, an electromagnet, a piezoelectric actuator, MEMS or a shape memory alloy.

15.-18. (canceled)

19. A method performed by a device including an optical element assembly configured to focus light, the method comprising:
providing a plurality of focus settings based on a change in a position of the optical element assembly, wherein the optical element assembly is configured to receive light along an axis of motion at a first end of the optical element assembly;
providing a first actuator coupled to the optical element assembly that is configured to cause the change in the position of the optical element assembly;
providing a second actuator directly connected to a surface of a second end of the optical element assembly that is configured to retain the optical element assembly in a resulting position after the change in the position, wherein the second actuator is configured to retain the optical element assembly by applying at least one force to the second end of the optical element assembly that is substantially parallel to an axis of motion of the optical element assembly, wherein the second end of the optical element assembly is opposite the first end;
reducing power to the first actuator based on the second actuator retaining the optical element assembly in the resulting position; and
increasing power to the second actuator to retain the optical element assembly in the resulting position based on the optical element assembly being in the resulting position.

20. (canceled)
